(19) United States
(12) Patent Application Publication
(10) Pub. No.: US 2021/0005119 A1
(43) Pub. Date: Jan. 7, 2021

(54) WIND ADJUSTABLE FLAG POLE

(71) Applicant: Larry Roy, Galveston, TX (US)

(72) Inventor: Larry Roy, Galveston, TX (US)

(21) Appl. No.: 16/503,249

(22) Filed: Jul. 3, 2019

(51) Int. Cl. G09F 17/00

(52) U.S. Cl. CPC G09F 17/0091; G09F 2017/0008

(57) ABSTRACT

A flag pole for rotating during windy climate and thus preventing a flag from being tangled and/or wrapped around the flag pole. The flag pole has a plurality of sections, each of which has a first end and a second end. Each of the first ends of the plurality of sections being an insertion end and each of the second ends of the plurality of sections being a receiving end. A truck has a top and a first end and the first end of the truck is a receiving end. A base coupling the flag pole to a surface. The base has a coupler and a plate. The first end of the truck is coupled to the first end of a first of the plurality of sections. The first end of a second of the plurality of sections is coupled to the second end of the first of the plurality of sections. The second end of the second of the plurality of sections is coupled to the first end of a third section of the plurality of sections. At least one of the first end of the second of the plurality of sections and the first end of the third of the plurality of sections having at least one ball bearing.

### FIELD OF THE INVENTION

This invention relates to flag poles. More particularly, it relates to adjustable flag poles.

### BACKGROUND

A flagpole, flag mast, flagstaff, or staff can be a simple support made of wood or metal. If it is taller than can be easily reached to raise the flag, a cord is used, looping around a pulley at the top of the pole with the ends tied at the bottom. The flag is fixed to one lower end of the cord, and is then raised by pulling on the other end. The cord is then tightened and tied to the pole at the bottom.

The pole is usually topped by a flat plate or ball called a “truck” (originally meant to keep a wooden pole from splitting) or a finial in a more complex shape. Very high flagpoles may require more complex support structures than a simple pole, such as a guyed mast.

When blown by the wind, flags are subject to wave-like motions that grow in amplitude along the length of the flag. This is sometimes ascribed to the flag pole giving vortex shedding; however, flags that are held by lanyards also can be seen to flap.

Further, when blown by the wind, the flag can be wrapped around the flag pole. The flag must then be unwrapped from the pole or else it is undeterminable what the flag represents. Therefore, there is a need to provide a flag pole that can prevent the flag from being wrapped around a flag pole.

### BRIEF DESCRIPTION OF THE DRAWINGS

FIG. 1A is an illustrated view of an exemplary flag pole.

FIG. 1B is an illustrated highlighting of the exemplary flag pole of FIG. 1A.

FIG. 2 is an illustrated view of components of the flag pole of FIG. 1A and FIG. 1B.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

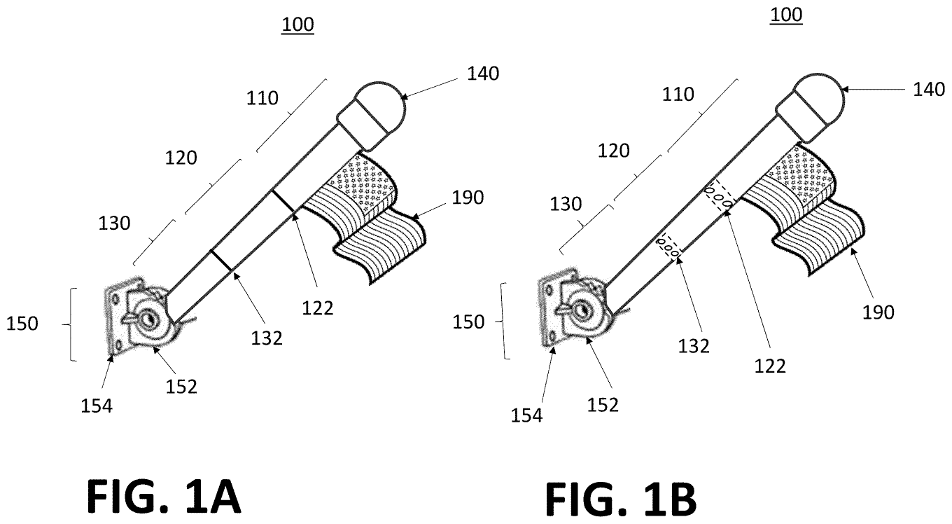

Referring to FIG. 1A, an exemplary flag pole 100 for preventing a flag 190 from wrapping on the flag pole 100 is presented. FIG. 1B is presented with FIG. 1A representing a view of components described herein. The flag pole 100 is useful for preventing high winds from rotating the flag 190 and wrapping it around or tangling on the flag pole 190. Thus, flag pole 100 rotates with the wind, preventing the flag 190 form getting tangled and/or wrapped up in the flag pole 100, ensuring the flag 190 display remains in place and is discernable by a spectator.

The flag pole 100 is preferably made of aluminum, but may be made of any strong, durable material such as steel, wood, titanium, etc. The flag pole 100 is preferably four (4) feet in length, but may be any length suitable for the flag 190 and location the flag 190 is to be displayed. The width and height of the flag pole 190 may be any width and height suitable for the flag 190 and location the flag 190 is to be displayed. The shape of the flag pole 100 is preferably cylindrical, but may be any shape such as rectangular, square, round, oblong, etc. The flag 190 is preferably an American flag, but may be any other type of flag such as a country's flag, a school flag, an adornment flag, etc.

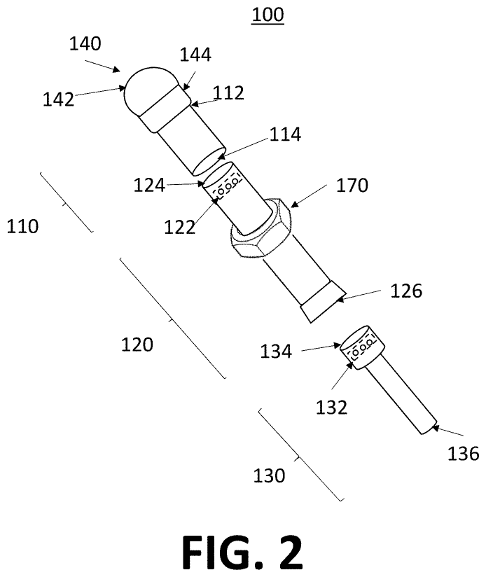

The flag pole 100 has a plurality of sections 110, 120, 130, a truck 140 and a base 150. The plurality of sections 110, 120, 130 is illustrated in FIG. 1A, FIG. 1B and FIG. 2 as three (3) sections, but this is for example purposes only and should be noted that the number of sections can be any number two (2) and greater.

The truck 140 is the top of the flag pole 100. The truck 140 is securely coupled to a first of the plurality of sections 110. The first of the plurality of sections 110 is coupled to a second of the plurality of sections 120. At the coupling of the first of the plurality of sections 110 to the second of the plurality of sections 120, one or more ball bearings 222 are contained within the flag pole 100. The ball bearings 222 for providing a rotatable, friction less movement of the flag pole 100.

A third of the plurality of sections 130 is coupled to the second of the plurality of sections 120. At the coupling of the third of the plurality of sections 140 to the second of the plurality of sections 120, one or more ball bearings 232 are contained within the flag pole 100. The ball bearings 232 for providing a rotatable, friction less movement of the flag pole 100.

The third of the plurality of sections 130 further is coupled to the base 150. The base 150 is useful for coupling the flag pole 100 to a surface such as a building, wooden pole, metal pole, etc.

The base 150 has a coupler 152 and a plate 154. The coupler 152 of the base 150 is coupled to the third of the plurality of sections 130 of the flag pole 100. The coupler 152 is coupled to the plate 154. The plate 154 of the base 150 may be coupled to a surface by a fastener. The fastener is preferably a screw, but may be any other type of fastener such as Velcro, lag bolts, nails, etc.

Moving now to FIG. 2, the exemplary flag pole 100 of FIG. 1A and FIG. 1B is further illustrated.

The flag pole 100 has the plurality of sections 120, 130, 140, the truck 140 and the base 150. The first of the plurality of sections 120 has a first end 122 and a second end 124. The truck 140 has a top 142 and a first end 144. The first end 122 of the first section 120 is an inserted end in that it is configured to be coupled inside of any receiving end. The second end 124 of the first section is a receiving end in that it receives an inserting end.

The first end 122 of the first section 120 of the flag pole 100 is coupled to the first end 144 of the truck 140 by placing the first end 122 of the first section 120 into the first section 144 of the truck 140. The first end 144 of the truck 140 is a receiving end such that it receives the first end 122 of the first section 120 into the inside of the first end 144 of the truck 140. The second end 124 of the first section 120 is a receiver of another section.

The second of the plurality of sections 120 has a first end 124 and a second end 126. The first end 124 of the second section 120 is an inserted end in that it is configured to be coupled inside of any receiving end. The second end 126 of the second section 120 is a receiving end in that it receives an inserting end.

The third of the plurality of sections 130 has a first end 134 and a second end 136. The first end 134 of the third section 130 is an inserted end in that it is configured to be coupled inside of any receiving end. The second end 136 of the third section 130 is a receiving end in that it receives an inserting end.

The first end 124 of the second section 120 has one or more ball bearings 122. The ball bearings 122 are useful for providing a smooth surface for the second section 120 to be rotated upon any force.

The first end 124 of the second section 120 is configured to be inserted into the second end 114 of the first section 110, thus creating a rotational coupling.

The first end 134 of the third section 130 has one or more ball bearings 132. The ball bearings 132 are useful for providing a smooth surface for the third section 130 to be rotated upon any force.

The first end 134 of the third section 130 is configured to be inserted into the second end 126 of the second section 120, thus creating a rotational coupling.

A locking nut 170 may be used to further secure the coupling of the first section 110 to the second section 120 and/or the second section 120 to the third section 130.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A flag pole for rotating during windy climate, comprising:
a plurality of sections, each of the plurality of sections having a first end and a second end, wherein each of the first ends of the plurality of sections being an insertion end and wherein each of the second ends of the plurality of sections being a receiving end;
a truck, the truck having a top and a first end, wherein the first end of the truck being a receiving end;
a base, the base for coupling to a surface, wherein the base having a coupler and a plate;
the first end of the truck coupled to the first end of a first of the plurality of sections;
the first end of a second of the plurality of sections being coupled to the second end of the first of the plurality of sections;
the second end of the second of the plurality of sections being coupled to the first end of a third section of the plurality of sections; and
wherein at least one of the first end of the second of the plurality of sections and the first end of the third of the plurality of sections having at least one ball bearing.

2. The flag pole of claim 1, wherein the flag pole being made of aluminum.

3. The flap pole of claim 1, wherein the flag pole being made of steel.

4. The flag pole of claim 1, wherein the plurality of sections being three (3).

5. The flag pole of claim 1, further comprising:
a flag, wherein the flag being for display.

6. The flag pole of claim 5, wherein the flag being an American flag.

7. The flag pole of claim 1, further comprising
a base, the base having a coupler and a plate;
the coupler being coupled to the second end of the third of the plurality of sections; and
the plate being coupled to a surface.

8. The flag pole of claim 7, wherein the surface being a building.

9. The flag pole of claim 7, wherein the surface being a pole.

10. The flag pole of claim 1, wherein when the wind blows, the ball bearings are configured to adjust each of the sections such that the flag being not tangled.

11. The flag pole of claim 1, wherein the flag pole being cylindrical in shape.
